(19) United States
(12) Patent Application Publication
(10) Pub. No.: US 2018/0300316 A1
(43) Pub. Date: Oct. 18, 2018

(54) SYSTEM AND METHOD FOR PERFORMING MESSAGE TRANSLATIONS

(71) Applicants: David Chissoe, Broomfield, CO (US); Rocky DeMott, Broomfield, CO (US)

(72) Inventors: David Chissoe, Broomfield, CO (US); Rocky DeMott, Broomfield, CO (US)

(21) Appl. No.: 15/490,135

(22) Filed: Apr. 18, 2017

(51) Int. Cl. G06F 17/28; H04L 12/58; G10L 15/22

(52) U.S. Cl. CPC G06F 17/289; H04L 51/38; G10L 15/22; H04L 51/046

(57) ABSTRACT

A system for performing message translation is provided. The system may include a translating device to receive one or more messages from one or more entities. The system may also include one or more translating units to translate the received messages from an original language to one or more different languages. Further, the system may include a communication device to render the translated messages to one or more entities.

### CROSS-REFERENCES TO RELATED APPLICATIONS

N/A.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD OF THE TECHNOLOGY

The present disclosure generally relates to the field of communications and, more specifically, to a system and a method for performing language translations.

### DESCRIPTION OF THE RELATED ART

As trade barriers continue to decline, more and more business is being done in different countries. As a result, language differences are playing a bigger part in this evolving global economy. However, it is very difficult to conduct business in another part of the world when the parties involved all speak a different language. Although translators are an option, they can be very expensive and it is sometimes difficult to be sure that they are actually conveying your message in the proper context and with the proper emphasis. Further, translators are not always readily available when you need them as well. For example, it is not cost efficient to have a translator accompany you during an entire business trip to make sure that you can communicate with the person you may come in contact, i.e. the hotel clerk, the taxi driver, etc.

There are lots of study courses available that would allow an individual to learn another language. However, it is not always practical to do so. Although some of these courses can be learned in the privacy of one's own home, it still requires a certain amount of time commitment and again these courses are not always affordable to every individual. For example, one would have to commit to a class schedule where they would also get interaction with other people attempting to learn the language. Further, an individual must also continue to use a language on a regular basis in order to maintain the knowledge of the language and the ability to speak it.

Therefore, what is needed is a system and a method for automatic language translation and communication which accepts speech input in one language and simultaneously provides an accurate near real-time natural fluent speech in another language.

### SUMMARY

In an embodiment, a system for performing message translation is provided. The system may include a translating device to receive one or more messages from one or more entities; one or more translating units to translate the received messages from an original language to one or more different languages; and a communication device to render the translated messages to one or more entities.

In another embodiment, an apparatus for performing message translation is provided. The apparatus may include a translating device to receive one or more messages from one or more entities; one or more translating units to translate the received messages from an original language to one or more different languages; and a communication device to render the translated messages to one or more entities.

In yet another embodiment, a method for performing message translation is provided. The method may include: receiving one or more messages from one or more entities; translating the messages from an original language of the entities that sent the messages into one or more different languages corresponding to the entities that is the intended recipient of the messages; and rendering the translated messages to the entities that is the intended recipient of the translated messages.

In still another embodiment, a computer-readable medium having computer executable instructions for performing message translation is provided. The computer-readable medium has computer executable instructions that may include: receiving one or more messages from one or more entities; translating the messages from an original language of the entities that sent the messages into one or more different languages corresponding to the entities that is the intended recipient of the messages; and rendering the translated messages to the entities that is the intended recipient of the translated messages.

### BRIEF DESCRIPTION OF THE DRAWINGS

The present invention is described in detail below with reference to the attached drawing figures, which are incorporated by reference herein and wherein:

FIG. 1 is a simplified and representative block diagram of a computer network;

FIG. 2 is a block diagram of a computer that may be connected to the network of FIG. 1;

FIG. 3A is a block diagram illustrating an exemplary embodiment of the invention;

FIG. 3B is block diagram illustrating another exemplary embodiment of the invention; and

FIG. 4 is a flowchart illustrating a process in accordance with exemplary embodiments of the invention.

### DETAILED DESCRIPTIONS

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent application, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent application (other than the language of the claims). To the extent that any term recited in the claims at the end of this patent application is referred to in this patent application in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the exemplary embodiments of the invention, further discussion of such software and ICs, if any, will be limited to the essentials with respect to the principles and concepts of the preferred embodiments.

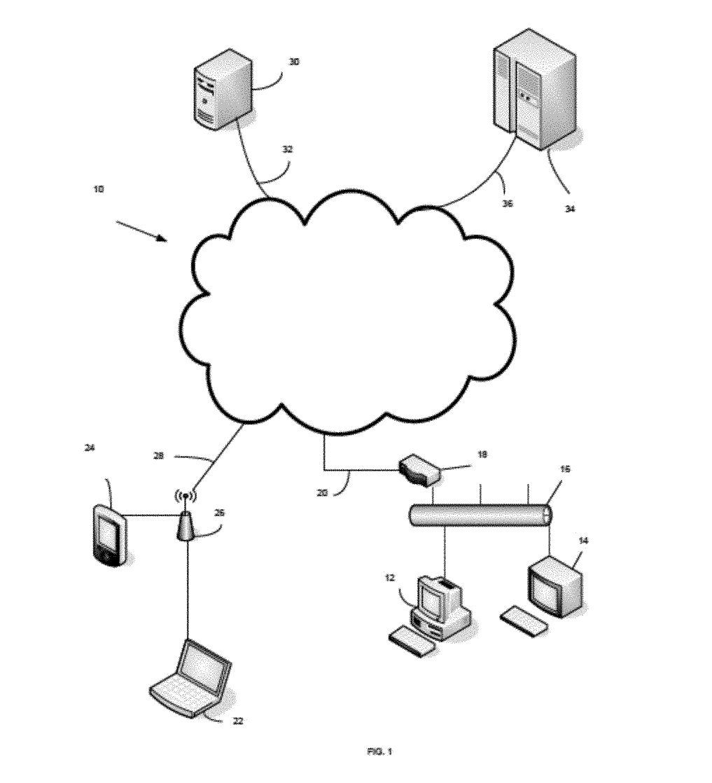

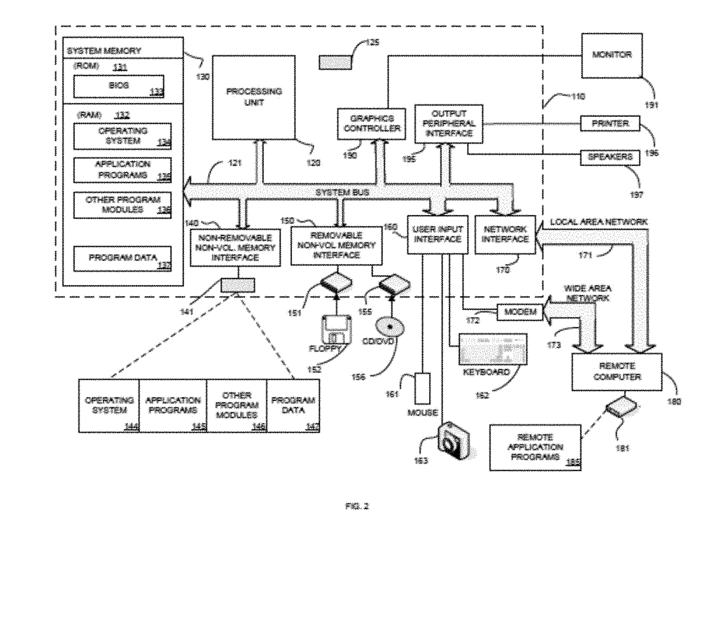

FIGS. 1 and 2 provide a structural basis for the network and computational platforms related to the instant disclosure.

FIG. 1 illustrates a network 10 that may be used to support a section 382 study analysis system. The network 10 may be the Internet, a virtual private network (VPN), or any other network that allows one or more computers, communication devices, databases, etc., to be communicatively connected to each other. The network 10 may be connected to a personal computer 12 and a computer terminal 14 via an Ethernet 16 and a router 18, and a landline 20. On the other hand, the network 10 may be wirelessly connected to a laptop computer 22 and a personal data assistant 24 via a wireless communication station 26 and a wireless link 28. Similarly, a server 30 may be connected to the network 10 using a communication link 32 and a mainframe 34 may be connected to the network 10 using another communication link 36. The server 30 and mainframe 34 may be exemplary destinations for Internet traffic related to analyzing communication data, as will be discussed in more detail below.

FIG. 2 illustrates a computing device in the form of a computer 110. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 may also include a cryptographic unit 125. Briefly, the cryptographic unit has a calculation function that may be used to verify digital signatures, calculate hashes, digitally sign hash values, and encrypt or decrypt data. The cryptographic unit 125 may also have a protected or secure memory for storing keys and other secret data. In addition, the cryptographic unit 125 may include an RNG (random number generator) which is used to provide random numbers. In other embodiments, the functions of the cryptographic unit 125 may be instantiated in software or firmware and may run via the operating system or on a device.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and cursor control device 161, commonly referred to as a mouse, trackball or touch pad. A camera 163, such as web camera (webcam), may capture and input pictures of an environment associated with the computer 110, such as providing pictures of users. The webcam 163 may capture pictures on demand, for example, when instructed by a user, or may take pictures periodically under the control of the computer 110. Other input devices (not shown) may include a microphone, joystick, game pad, satellite dish, scanner, or the like. These and other input devices are often connected to the processing unit 120 through an input interface 160 that is coupled to the system bus, but may be connected by other interface and bus structures, such as a parallel port, game port or a universal serial bus (USB). A monitor 191 or other type of display device is also connected to the system bus 121 via an interface, such as a graphics controller 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181.

The communications connections 170-172 allow the device to communicate with other devices. The communications connections 170-172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

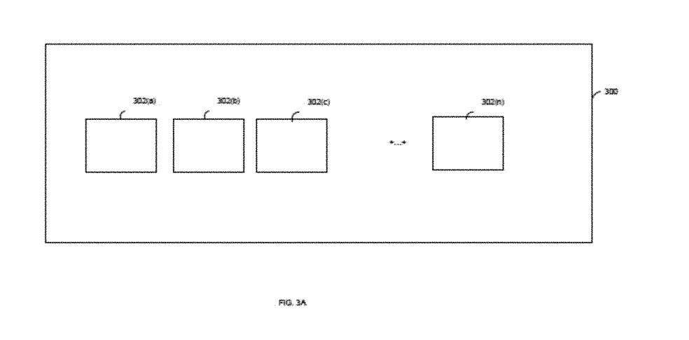

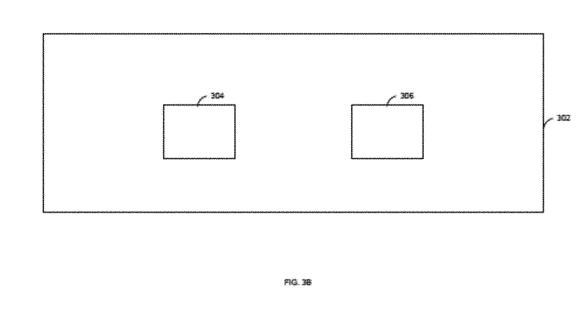

FIGS. 3A and 3B illustrate a block diagram 300 in accordance with an exemplary embodiment of the invention. As shown in FIG. 3A, the translator device 300 may include one or more translating units 302(a) . . . 302(n) for receiving, translating, or transmitting one or more written messages or verbal messages. In some embodiments, the messages may include one or more voice inputs, audio inputs, video inputs, from one or more entities or one or more data sources. In some embodiments, the translator device 300 may include one or more modules, components, etc., implemented in a software, firmware, and/or hardware.

As shown in FIG. 3B, the translating units 302(a) . . . 302(n) may include a message transceiver unit 304 and a language conversion unit 306. In some embodiments, the message transceiver unit 304 may include a receiver, a transmitter, a transceiver, or any known message transmitting device known to those skilled in the art. In some embodiments, the language conversion unit 306 may convert or translate a message from one language into one or more languages.

In some implementations, the translator device 100 may be implemented in software and/or firmware that runs as processing instructions executed by one or more processors and the instructions stored in one or more memories. In an embodiment, the translator device 100 may include one or more language recognition modules (not shown) to identify the language of one or more entities. The language recognition modules may be stored in a memory or used in connection with a memory. The entities may be a human, a machine, a business entity (i.e. a company), software application, or any message generating entity known to those skilled in the art. In another embodiment, the translator device 100 may include one or more language translating engines (not shown) to translate one or more languages into one or more languages. In some embodiments, the translator device 100 may include a communication device (not shown) to output the results or messages of the translation engines. As a result, the one or more entities may be able to communicate with each other in the same language in any time manner. The time manner may be simultaneously, in real time, on demand, asynchronously, or a specific time designated by either entity. The communication device may be a speaker, a display, or any means for rendering a message to an entity known by those skilled in the art.

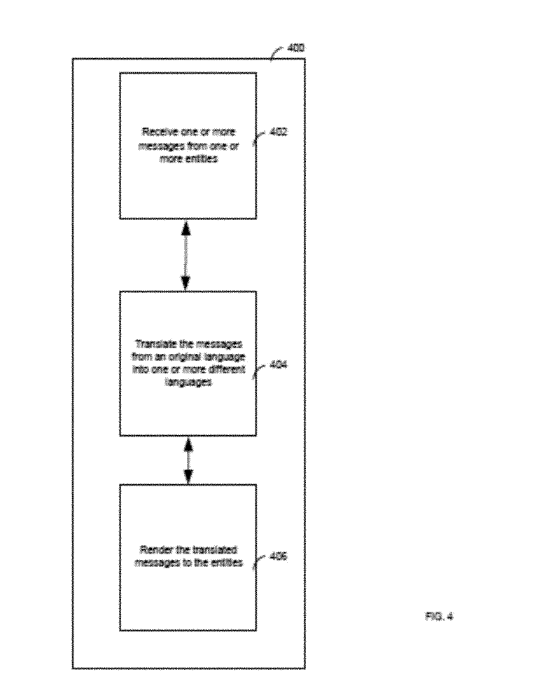

FIG. 4 illustrates a flowchart describing a process 400 in accordance with exemplary embodiments of the invention. At block 402, one or more messages may be received from one or more entities. At block 404, one or more messages may be translated from an original language of the entities that sent the messages into one or more different languages corresponding to the entities that is the intended recipient of the messages. At block 406, the translated messages may be rendered to the entities that is the intended recipient of the translated messages. Additionally, the messages may be communicated bidirectionally among the different entities.

In an embodiment, application software, also known as an application or an “App”, may be a complete, self-contained program that performs a specific function directly for the user. Apps may be used to facilitate enterprise software, accounting software, office suites, graphics software, messaging and media players. Messaging systems, such as instant messaging, Short Message System (SMS) and email, are typically text-based chatting communication between two or more people using a device such as a phone, PDA, laptop, personal computers or any communication platform known to those skilled in the art. The messages may be conveyed over a private network or public network such as the Internet.

In yet an embodiment, the translator device 100 may include an apparatus that can be in-built or a removably connectable peripheral device. In some embodiments, the apparatus may be implemented in the form of one or more chips that would contain all natural languages embedded into the chips or via a cloud network. The chips may be incorporated or removably connected (via a USB port) to one or more communication devices, peripheral devices, or accessory devices.

In another embodiment, a mobile App may be used for translating voice, audio, text, or currency in the language understood by an entity. In some implementations, the mobile App may include a translations tab that can be selected by the entity on a tab displayed on a cell phone screen, a car screen, a computer, television, or any data displaying device known by those skilled in the art for the selection of the entity's language and the corresponding currency. In other embodiments, the mobile App may update the daily currency by connecting to the internet via a cell phone or via a Global Position System (GPS) connection when in a vehicle. Further, the currency conversion display may be based on a selection tab for the selected language.

In still another embodiment, the system may include automatically translating the audio and/or video inputs understood by an entity in the following implementations: a mobile phone, a smart phone, a tablet, a television, a radio, a gaming console, a DVD/CD/Blu ray player, a set top box, a vehicle informatics system, a telematics system, a navigation system, or any implementation known by those skilled in the art.

In yet another embodiment, the apparatus may include one or more language translation engines. The language translation engines may include one or more modular software components for performing one or more specific tasks. In some embodiments, the engines and basic tasks may include: speech-to-text converters, text-to-speech converters, text-to-text translators, text compression, real-time speech translation, batch translation of online documents, speech compression, currency conversion, and encryption. In other embodiments, the engines may be open-source or proprietary (provided exclusively by a single third party).

In still another embodiment, the system may include a communication module. The communication module may include a cellular network, an IMS network, a Push to Talk over Cellular (PoC), telecommunication, VOIP, satellite communication, wireless communication, micro USB, wireless, 802.11 protocols, Bluetooth, ZigBee, IR or any type of network known to those skilled in the art.

In an embodiment, the language recognition module may include one or more predefined parameters. The predefined parameters may include GPS coordinates, a location, a country, a state, words or phrases, a religion, a pin code, or any parameter data known to those skilled in the art.

In another embodiment, the apparatus can be installed in either the USB port in a smart TV or can be installed on the chip board inside the smart TV. It can be initiated using the Universal Remote Setup with the remote control. Upon initiation, any voice transmission can be in the entity's selected language. Also, any video chat application (i.e. Skype™) used on the smart TV can also be converted to the selected language of the user.

In yet another embodiment, the apparatus can be installed in either the micro USB port in a smart phone or can be installed on the chip board inside the smart phone. Upon initiation, the translation chip can convert all calls and text messages to the language of the entity and can automatically translate and pick up the language of the caller and convert it to the language of the other caller, and vice-versa. The translation chip may be configured to convert the language of video chat, text messaging, and email in the caller's desired language. The video camera on the phone can also be used to read information when it hovers over a readable item and converts it to the language of the entity, including money amounts (such in a cafe menu) to current money conversion to the entity's currency.

In some embodiments, the device can be installed inside the chipboard of the laptop or the device can be connected using a USB port. Once activated, the tablet may do the same as with a TV and cell phones, i.e., convert movies, TV shows, emails, video chat messages to the language of the user and vice versa (in video chatting or text chatting).

In another embodiment, the device can be installed inside the chipboard of the computer or can be installed in a USB port of the computer. Once activated, emails, text, video chats, DVDs, CDs, movies, and TV shows can all be converted to the user's language.

In still another embodiment, the apparatus can be installed in either the USB port in a surround sound system or can be installed on the chip board inside a surround sound system. The chip can be activated by a listing on the setup menu and selecting from a listing of languages. It can be used to translate any movie, DVD, CD, or TV show to translate the audio into the selected language.

In some embodiments, the system may include gaming consoles. The device can be installed in either the USB port or inside the chipboard of the in the gaming consoles and may be activated with the use of controller when the console is connected to the TV. The gamer may select the language during gaming activity.

In another embodiment, the apparatus may allow users to watch and/or listen to movies in the desired language. Users may hear songs in their selected language in the actual voices of the singers, as if they are singing in that language.

In yet another embodiment, the system may display email and text messages and read and respond to such using the vehicle's speaker/audio system. The system may translate the text messages and email into the recipient's language or the vehicle's user language using the voice system already in the vehicle. The system may be implemented in anywhere inside vehicle and with accessories such as headphones. In some embodiments, the system may translate news broadcasts.

In still another embodiment, the apparatus may be embedded in or implemented with hearing aids, ear pieces, glass attachments, camera glasses, electronic glasses and/or goggles, etc. or sensory enhancement tools known to those skilled in the art.

Many different arrangements of the various components depicted, as well as components not shown, are possible without departing from the spirit and scope of the present invention. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

1. A system for performing message translation, comprising:
a translating device to receive one or more messages by user equipment operable in a communication system from one or more entities;
one or more translating units to translate the received messages in the communication system from an original language to one or more different languages; and
a communication device to render the translated messages in the communication system using at least two translation engine of: speech-to-text converters, text-to-speech converters, text-to-text translators, text compression, real-time speech, batch translation of online documents, speech compression, and currency conversion to one or more entities.

2. The system of claim 1, wherein the system includes a message transceiver unit to receive the messages.

3. The system of claim 1, wherein the translating units include a language conversion unit to translate the messages.

4. The system of claim 1, wherein the messages are translated in real time.

5. The system of claim 1, wherein the communication device includes a speaker.

6. The system of claim 1, wherein the communication device includes a display.

7. An apparatus for performing message translation, comprising:
a translating device to receive one or more messages by user equipment operable in a communication system from one or more entities;
one or more translating units to translate the received messages in the communication system from an original language to one or more different languages; and
a communication device to render the translated messages in the communication system using at least two translation engine of: speech-to-text converters, text-to-speech converters, text-to-text translators, text compression, real-time speech, batch translation of online documents, speech compression, and currency conversion to one or more entities.

8. The apparatus of claim 7, wherein the apparatus includes a message transceiver unit to receive the messages.

9. The apparatus of claim 7, wherein the translating units include a language conversion unit to translate the messages.

10. The apparatus of claim 7, wherein the messages are translated in real time.

11. The apparatus of claim 7, wherein the communication device includes a speaker.

12. The apparatus of claim 7, wherein the communication device includes a display.

13. The apparatus of claim 7, wherein the apparatus includes a mobile application.

14. The apparatus of claim 7, wherein the apparatus is a tablet.

15. A method for performing message translation, comprising:
by user equipment operable in a communication system: receiving one or more messages from one or more entities;
translating the messages in the communication system from an original language of the entities that sent the messages into one or more different languages corresponding to the entities that is the intended recipient of the messages; and
rendering the translated messages in the communication system using at least two translation engine of: speech-to-text converters, text-to-speech converters, text-to-text translators, text compression, real-time speech, batch translation of online documents, speech compression, and currency conversion to the entities that is the intended recipient of the translated messages.

16. The method of claim 15, wherein the messages are translated in real time.

17. The method of claim 15, wherein the translated messages are rendered in real time.

18. The method of claim 15, wherein the method is implemented as a mobile application.

19. The method of claim 15, wherein the translated messages are communicated bidirectionally between the entities.

20. The method of claim 15, wherein the messages include a voice input.
